(19) United States
(12) Patent Application Publication
(10) Pub. No.: US 2019/0065783 A1
(43) Pub. Date: Feb. 28, 2019

(54) COMPUTATIONALLY IMPLEMENTED METHOD WITH ENABLED LOCKDOWN CODE AND CAPABILITY

(71) Applicant: MALLORY DYER, COOLIDGE, AZ (US)

(72) Inventor: MALLORY DYER, COOLIDGE, AZ (US)

(21) Appl. No.: 15/690,285

(22) Filed: Aug. 30, 2017

(51) Int. Cl. G06F 21/62; H04L 29/06; H04L 9/30

(52) U.S. Cl. CPC G06F 21/6281; G06F 21/629; H04L 9/30; H04L 63/10

(57) ABSTRACT

The present invention relates to a computer implemented method wherein the computer implemented method enables its use on a user's smart device, wherein the use of the computer implemented method by the mentor enables the mentor to control the computer implemented method of the user through the lockdown mode. The lockdown mode of the mentor enables him/her to control the computer implemented method of the user and thus lock the smart device of the user to restrain the user from opening any other application, close out of the computer implemented method, or receive any notifications during the use of the computer implemented method. The lockdown mode enables the mentor to be notified if the user tries to exit the app or put the app to the background in any way.

### FIELD OF THE INVENTION

The present invention generally relates to a computer implemented method designed to operate on the at least one user smart device for enabling the at least one mentor to control the operation of the smart device by restricting the smart device to work only as a computer implemented method by simply blocking at least one of a call, an internet usage, a text or the combination thereof feature of the smart device to enable the smart device to be used for educational purpose or any other purpose of the at least one user interest. Further the invention also provides a direct accessibility feature with an enabled lockdown code and capability.

### BACKGROUND OF THE INVENTION

An electronic calculator is a small, portable electronic device used to perform both basic operations of arithmetic and complex mathematical operations.

In addition to this, the calculator is an educational tool that allows students to reach higher levels of mathematical understanding, reasoning, number sense, and computer implemented methods. Four functions, scientific and graphing calculators as well as calculators with computer symbolic algebra manipulation capabilities provide new pedagogical enhancement opportunities. They afford students learning tools that complement, but do not replace, mental and paper and pencil skills and they expand the student's ability to solve problems by providing multiple solution techniques.

However, the changes in our economy have greatly impacted students, many students do not have the funds to purchase a calculator wherein, almost every student that enrolls in college needs a graphing calculator for some or other course and the graphical calculators used by the students in their problem-solving subjects are out of the reach of many people. Moreover, calculators or the similar devices present in the market are only able to meet the needs of a calculator which can perform the scientific and arithmetic calculations and are not provided with any additional features. Although calculators are available in our smart devices, they are not enabled with a feature which makes them perfect for use for school and college examinations. Neither the smart phones provided with calculators or graphical calculators posses a lock down mode feature wherein the student is enabled only to use the applications provided by the calculator and not the use of any other smart phone feature.

The various smart devices provide several features wherein these features and applications provided in the smart devices are not useful at the time a student is studying. The features available in these smart devices lead to the diversion of the student's mental attention and distract them from their studies. The various applications installed on our smart devices are sometimes time killing and lead to a disturbance when a person is trying to concentrate on his/her work and the use of an application within his/her smart device that pertains to their studies.

Therefore, there remains a need to overcome the above-mentioned problems and our invention resolves this entire problem.

### SUMMARY OF THE INVENTIION

The main objective of the present invention is to overcome the limitations of the prior arts by providing a computer implemented method designed to operate on the at least one user smart device for enabling the at least one mentor to control the operation of the smart device by restricting the smart device to work only as a computer implemented method by simply blocking at least one of a call, an internet usage, a text or the combination thereof feature of the smart device to enable the smart device to be used for educational purposes and various other purposes. Further the invention also provides a direct accessibility feature with an enabled lockdown code and capability.

The present invention of a computer implemented method enables its use on the at least one user smart device and runs on the Android and iOS platforms but is not limited to only this. The present invention enables at least one user to use the computer implemented method on his/her smart device and enables the at least one mentor to use the same computer implemented method on the same time over a same network, wherein the use of the computer implemented method by the at least one mentor enables the mentor to control the operation of the computer implemented method operated by the at least user through a lockdown mode. The lockdown mode used by the at least one mentor enables him/her to control the computer implemented method of the at least one user and thus lock the smart device of the at least one user to restrain the at least one user from opening any other application, close out of the computer implemented method, or receive any notification during the use of the computer implemented method. Therefore, converting the at least one user smart device solely to the computer implemented method, wherein during the lockdown mode the at least one user cannot exit out of the computer implemented method, cannot make or receive calls, send texts, open other computer implemented methods, receive new notifications, access the internet, access social media sites, or take pictures, also the user's smart device does not make any noise during the lock down mode. Therefore, the computer implemented method with enabled lockdown mode works as an alert system for the at least one mentor to access the at least one user at the time of session created by the at least one mentor.

Moreover, the present invention of the computer implemented method is used by a teacher wherein, the teacher is enabled to create a group of students on the computer implemented method and then control the use of the computer implemented method for those groups of students. The teacher herein is enabled to create a session opt in for the session from his/her own side and is further enabled to send the initiated session request to the at least one user over the same network.

Also, the parent is enabled to create a login/ID for the user, wherein the user is enabled to login using the email/ID created by his/her parent or by the user and the user remains in the parent's account until the parent deletes the user from his/her account. Herein, the user name shows up in some chosen color on the parent's home page and the parent instructs the user to open the computer implemented method and select “Lockdown Mode” which then prompts the user to login using the account created by the parent.

Lastly, in the present invention if a user is in class/testing center and the computer implemented method is in lock down mode, the teacher prompts the user to go to “Lockdown Mode” and the user have to sign in using his/her email/ID (if they have forgotten this, the teacher is enabled to look it up in the class settings. The user cannot change the email linked to the account or change the ID. Once a user logs in, his/her name appears in some chosen color. If the user tries to open any other application or exit out, his/her name/profile appears in red on the mentor's side and a sound and notification is emitted to notify the teacher/mentor.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the schematic view of the given invention according to an embodiment of the invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

The present invention relates to a computer implemented method which enables its use on the at least one user or the at least one mentor smart device and runs on Android/IOS platforms but not limited to these only. The present invention enables at least one user to use the computer implemented method on a smart device and enables at least one mentor to use the same computer implemented method at the same time connected to each other over a same network, wherein the use of the computer implemented method is for controlling the computer implemented method of the user through the lockdown mode by the mentor. The lockdown mode of the mentor enables him/her to control the computer implemented method of the user and thus lock the smart device of the user to restrain the user from opening any other application, close out of the computer implemented method, or receive any notification during the use of the computer implemented method. Therefore, converting the user's smart device solely into a computer implemented method, wherein during the lockdown mode wherein the user cannot exit out the computer implemented method cannot call, send text, open other application, receive new notification, open internet, other social media sites, or take pictures and the user's smart device do not make any noise during the lock down mode.

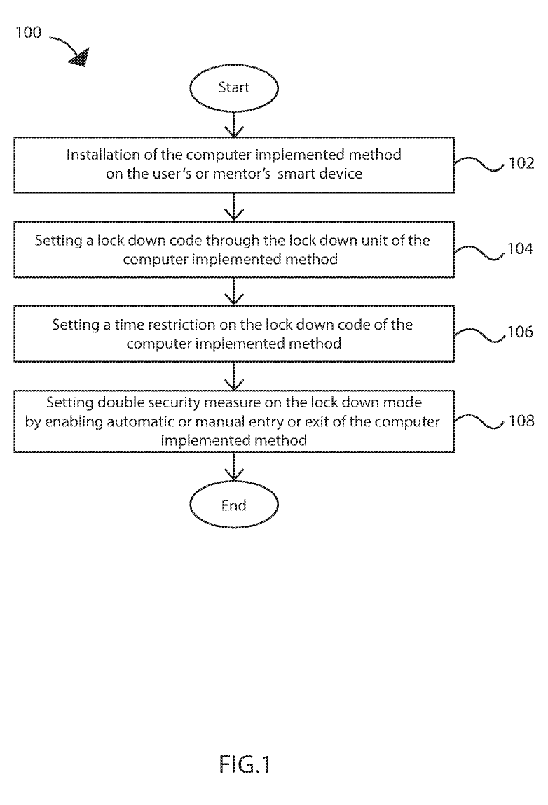

FIG. 1 illustrates the flow chart of computer implemented method [100] which is the schematic view of the given invention.

STEP. 102 of FIG. 1 illustrates creating an account on computer implemented method for both including at least one of the user and for at least one of the mentor, wherein the at least one user includes the student and the at least one mentor includes the teacher, proctor or the parent of at least one user. The teachers, parents, proctors and students get registered on the computer implemented method. A user and a mentor cannot get access to the computer implemented method until he/she is registered. Each login takes the user and the mentor to a specific page customized for each group of and user. The mentor signs up with an email and creates a username and password. A user logs in with an email and this generates a unique ID that is alphanumeric and case sensitive. This helps to associate the right user with their classes, avoid confusion if a user has the same name as another user and ensures the correct user is registering to join a lockdown session or take the test with the mentor.

STEP. 104 of FIG. 1 illustrates setting a lockdown code by using a lock down unit, wherein the lock down unit enables entering the lockdown code by at least one mentor to affect at least one user's smart device, wherein when the user's smart device is in lockdown mode, it has a green stripe across the top. Also, after entering the lockdown code there appears a notification enabling at least one mentor to know about the status of at least one user. If at least one of the user's using the computer implemented method on his/her smart device tries to exit the computer implemented method without the mentor's permission or tries to open a different application during lockdown mode the green stripe is removed and his/her name and profile turns red and a noise and notification is issued from the at least one mentor's computer implemented method to alert at least one of the mentors. At least one of the mentor can engage the user's smart device in the lock down mode individually or do a mass lockdown for an entire group of users through the computer implemented method. This also enables a mentor to select one of the individualized lockdown codes and it then prompts the user to log in on the device using his/her email/username and password. This prevents friends or those who should not have the ability to lockdown a device from doing so. Only those who are registered as a teacher, proctor or parent can lockdown a device. Also, the computer implemented method is provided with a zoom in and zoom out feature.

STEP. 106 of FIG. 1 illustrates setting a time restriction on the lockdown code, wherein the time restriction on the lockdown code enables the user's smart device to function as the computer implemented method for the set period. In the present invention of the computer implemented method the lockdown code provided via lock down unit expires after a period allotted by at least one of the mentors on at least one of the users' smart devices. This further enables its use for the classroom purposes and for various examination purposes. For example, a computer implemented method running on the user's smart device, wherein the mentor themselves sets a lockdown code restriction of a time limit for 1 hour and 30 minutes for example, to use during class time or possibly a two-hour (or more) restriction limit for exams to be used in class or in a work place or while doing homework at home. The smart device remains in lockdown mode until the time runs out, wherein the smart device automatically returns to its normal functionality. While the user's smart device is in the lockdown mode the name and profile of the user is shown in green on the mentor's computer implemented method and there is a green stripe across the top of the device on the user's screen. If the user attempts to close out of the computer implemented method or open any other application, his/her name and profile turns red on the mentor's computer implemented method and the green stripe is removed on the user's screen. If the user is not in lockdown mode, no border or stripe color is displayed around the screen.

STEP. 108 of FIG. 1 illustrates a double security measure, wherein the double security enables both the entry and exit to the lockdown unit by an enabled time restriction and upon entering the unique lockdown code also the mentor herein is enabled to receive an alert if the at least one user tries to leave the lockdown session before the restricted time period. Herein, the entry of at least one of the users from the lock down unit is done either by the mentor entering the lockdown code manually, sending the user a push notification with the lockdown code or by providing the lockdown code via email to the user. The exit is by the timer reaching the end of its allotted time and releasing all users from lockdown mode or the mentor manually removing individual users from their end from the lockdown session. In case of the entry of the user through lockdown code, the user opens the computer implemented method on his/her smart device wherein, the user enters the computer implemented method by a lockdown code provided by at least one of the mentors and the mentor is also able to remove the user from the lockdown mode by manually removing the user from the lockdown session on the mentor's device. In case of the entry and exit of the user through timer, the mentor is enabled to restrict the use of the computer implemented method via timer wherein, when the timer runs out, the user automatically gets logged out of the computer implemented method. The mentor is also to add additional time to the lockdown session. In case of the entry and exit of the user through date, the mentor is enabled to set a date restriction which enables the user to access the computer implemented method till the set date and the lock down code automatically expires after the set date. The mentor will also be able to schedule lockdown sessions for users. Also, the computer implemented method implements automatic and manual date restrictions for the usage of the computer implemented method by at least one user or by at least one mentor, wherein automatic date restriction is enabled by the computer implemented method itself.

In the preferred embodiment of the present invention the method is used by a teacher wherein, the teacher is enabled to register on the computer implemented method, and is also enabled to create a group of students from the class. The teacher provides the group of students a name and a unique code. The students enter the group by two ways:

I. The teacher is enabled to send the students a unique code for enabling the lockdown mode and have the student text/email it to a general account; or
II. The teacher is enabled to add students manually by entering their email/unique code that is linked with the student's account.

Once a student is registered into an account, his/her name appears in black on the roster displayed on the computer implemented method of the teacher. The teacher selects the unique ID appearing by the name of the student in the roster (in case they have students with the same name). When the teacher wants to set the group of students into lockdown mode, the teacher first selects the group of students and customizes the computer implemented method if he/she chooses to do so. To customize the computer implemented method, the teacher clicks the link which pulls up all computer implemented method functionalities. The teacher is enabled to “X” out any functions he/she does not want the student to use at that time or within a date and time range. The teacher may choose to share notes, formulas or other aids to the users. The computer implemented method herein is also enabled to act like an online platform or an online portal where the at least one mentor or a teacher can share notes relating to various subjects, can share various guidelines, formulas or the combination thereof. The teacher further is enabled to tell the students to open the computer implemented method on their smart device and select the “lockdown mode” to join a lockdown session. The student then is prompted to log in and enter their email/ID linked to the account if he/she is not already logged in. The student then enters the lockdown code provided by the teacher/mentor to join. Once the student has logged in, his/her name and profile now appears in green and his/her smart device has a green stripe on the top of his/her screen. If a student tries to back out at this point or force exit of the lockdown, his/her name and profile goes to red and the green stripe is removed. As the students are all logging in, the teacher enters the timer and the lockdown code that is unique and automatically generated. Once all student's names are in green, the teacher select “start session.” When the teacher does this the student's device is now in Lockdown and the green stripe appears across the top of the student's device. If the student tries to exit or open another application at this point, their name and profile appears in red, the stripe on his/her smart device is removed, and the website/app make a noise and sends a notification to notify the teacher. The student's profile will also automatically move to the top of the list of students. If the teacher is controlling it by their own device, the will be alerted by a notification banner. The student also is not able to have access to the computer implemented method until he/she actuates “join session.”

In other embodiment of the present invention if a student is in class and the computer implemented method is in lockdown mode, the teacher prompts the student to go to “Lockdown Mode” and the student must sign in using his/her email/ID (if they have forgotten this, the teacher is enabled to look it up in the class settings). The student cannot change the email linked to the account nor the ID. Once a student logs in his/her name and profile appears in green and if he/she tries to open any other application or exit out his/her name appear in red, will move to the top of the class list, and notify the teacher.

In another embodiment of the present invention, the parent is enabled to create a login/ID for the user, wherein the user is enabled to login using the email/ID created by his/her parent or by the user and the user remains in the parent's account until the parent deletes the user from his/her account. Herein, the user's name shows up in black on the parent's home page. The parent can open the computer implemented method and select “Lockdown Mode” which then prompts the user to login to their account or join a lockdown session. Once the user has done this, his/her name appears in green on the computer implemented method of the parent and the parent is then enabled to enter in a timer and a unique lockdown code is generated. Once the parent hits “start session” the unique code is generated and the parent can share it with the user via email or a push notification. The parent can also manually enter the code into the user's device. Once the user has the code entered into his/her device, the user selects “join session” option to open the computer implemented method and a green stripe appears across the top of the device, showing it is in lockdown mode. The parent then unlocks the user device manually, through his/her own computer implemented method or allows the timer to run out. Also, in response to an authorization of the lockdown code entered on the smart device via the at least one user enables the at least one user smart device to function as the computer implemented method for the set time period and wherein the lockdown code is enabled to restrict the at least one user smart device to access at least one of a text, a calling, an application, an internet or the combination thereof features over his/her smart device for the set time period.

In yet another embodiment the computer implemented method enables automatic deletion of history of at least one user, wherein the history includes the at least one user preferences, the at least one user attendance record, time restriction for the various lockdown sessions initiated over the smart device, various key strokes used by the at least one user on its smart device, various browsing history or any combination thereof. The deletion is either enabled by the at least one mentor or by the at least one use. To be used for attendance, lengths of lockdown session, keystrokes of the calculator

In yet another embodiment the computer implemented method also enables providing several data mining options showing the usage of the computer implemented method and its features to indicate statistics on the performance of the users, wherein the data mining options relates to a computational process of discovering patterns in large data sets involving methods at the intersection of artificial intelligence, machine learning, statistics, and database systems. Also, the computer implemented method provides variation for educational and testing purposes like access to a dictionary, thesaurus, calculator, formula sheets and other reference and tool options for various subjects to at least one user and by at least one mentor.

In yet another embodiment the computer implemented method is enabled to be used in big testing centers conducting exams for any entrance in private or governmental institute/services or any combination thereof.

While the invention has been described in detail with specific reference to preferred embodiments thereof, it is understood that variations and modifications thereof may be made without departing from the true spirit and scope of the invention.

What is claimed is:

1- A computer implemented method comprising a session initiating and notification system enabled to communicate with various smart devices over a network for sending a session request initiated via the at least one mentor for at least one user smart device over the same network; wherein the at least one user is enabled to join in for the session only after entering a lockdown code; and wherein the computer implemented method is further enabled to restrict the at least one user smart device to access at least one of a text, a calling, an application, an internet or the combination thereof features over his/her smart device for the set time period.

2- The method in claim 1; wherein after entering the lock down code there appears a notification enabling at least one mentor to know about the status of at least one user.

3- The method in claim 1; wherein the computer implemented method implements automatic and manual date restrictions for the usage of the computer implemented method by at least one user or by at least one mentor.

4- The method in claim 1; wherein the computer implemented method further enables automatic deletion of history of at least one user wherein the deletion is either enabled by at least mentor or at least one user.

5- The method in claim 1; wherein the computer implemented method provides several data mining options showing the usage of the computer implemented method and its features to indicate statistics on the performance of the users.

6- The method in claim 1; wherein the computer implemented method further provides variations for educational and testing purposes like access to a dictionary, thesaurus, calculator, formula sheets and other reference and tool options for various subjects to at least one user and by at least one mentor.

7- The method in claim 1; wherein the computer implemented method also enables the at least one mentor to share notes, formulas or other aids to the at least one user.

8- The method in claim 1; wherein the lockdown code created further comprises individual and mass lockdown code features.

9- The method in claim 1; wherein the computer implemented method provides double security measures, wherein the double security enables both the entry and exit from the lockdown unit by enabling a time restriction on the lockdown code.

10- A lockdown code to restrict at least one user smart device to work as a computer implemented method comprises the steps of:
a- setting a lockdown code by using a lockdown unit enabled on a computer or smart device, wherein the lockdown unit enables entering the lockdown code via at least one of a mentor in a smart device of at least one of a user;
b- setting a time restriction on the lockdown code, wherein the time restriction on the lockdown code enables the user's smart device to function as the computer implemented method for the period of time; and
c- exiting the lock down unit, wherein exiting through the lockdown unit is enabled by the timer running out or the mentor manually removing the user.

11- The method in claim 10; wherein after entering the lock down code there appears a notification enabling at least one mentor to know about the status of at least one user.

12- The method in claim 10; wherein the computer implemented method implements automatic and manual date restrictions for the usage of the computer implemented method by at least one user or by at least one mentor.

13- The method in claim 10; wherein the computer implemented method further enables automatic deletion of history of at least one user wherein the deletion is either enabled by at least mentor or at least one user.

14- The method in claim 10; wherein the computer implemented method provides several data mining options showing the usage of the computer implemented method and its features to indicate statistics on the performance of the users.

15- The method in claim 10; wherein the computer implemented method further provides variations for educational or non-educational and testing purposes like access to a dictionary, thesaurus, calculator, formula sheets and other reference and tool options for various subjects to at least one user and by at least one mentor.

16- The method in claim 10; wherein the computer implemented method also enables the at least one mentor to share notes, formulas or other aids to the at least one user.

17- The method in claim 10; wherein the lockdown code created further comprises individual and mass lockdown code features.

18- The method in claim 10; wherein the computer implemented method provides double security measures, wherein the double security enables both the entry to the lockdown unit by enabling a time restriction and entering the unique lockdown code and if the mentor will be alerted if the user tries to leave the lockdown session.
